(19) United States
(12) Patent Application Publication
(10) Pub. No.: US 2003/0131132 A1
(43) Pub. Date: Jul. 10, 2003

(54) Method and system for a routing server for selecting a PSTN gateway

(76) Inventors: Shih-An Cheng, Milpitas, CA (US); Eugene Voznesensky, Redwood City, CA (US); Jesse Hong, San Jose, CA (US)

Correspondence Address: Andrew Romero, Renner, Otto, Boisselle & Sklar, LLP, 1621 Euclid Avenue, Nineteenth Floor, Cleveland, OH, 44115, US

(21) Appl. No.: 10/046,356

(22) Filed: Jan. 10, 2002

(51) Int. Cl. G06F 15/173

(52) U.S. Cl. 709/239

(57) ABSTRACT

A method and system for a Voice-over-Internet Protocol (VoIP) system is disclosed. The VoIP system includes a network configured to allow voice data to be transmitted and received over the network. Further, the network includes a routing server configured to automatically determine and identify a termination PSTN gateway from a plurality of termination PSTN gateways. Additionally, the VoIP system includes at least one VoIP client operatively coupled to the network to transmit and receive voice data over the network. Further, the at least one VoIP client connects to the termination PSTN gateway in order to transmit and receive voice data. Further, the VoIP system includes one or more of a gateway monitor, a routing cost policy server or a routing plan database. The gateway monitor is configured to provide to the routing server the status information on the plurality of termination PSTN gateway. The routing cost policy server is configured to provide to the routing server cost information. The routing server may extract information on the at least one VoIP client from the routing plan database.

### TECHNICAL FIELD

The present invention generally relates to Internet Protocol (IP) telephony and, more specifically, relates to a method and system for a routing server for selecting a PSTN gateway.

### BACKGROUND ART

IP telephony is a collection of technologies that emulates and extends today's circuit-switched telecommunications services to operate on packet-switched data networks based on the Internet Protocol (IP). IP telephony encompasses the terms “Internet Telephony”, “voice-over-IP” (VoIP), “video-over-IP”, and “fax-over-IP”, and extends those capabilities even further to include new telecommunications applications made possible by the convergence of voice, video and data. “Voice-over-IP” (VoIP) technology enables the real-time transmission of voice signals as packetized data over “IP networks” that employ the Transmission Control Protocol (TCP), Real-Time Transport Protocol (RTP), User Datagram Protocol (UDP), and Internet Protocol (IP) suite, for example.

A conventional Public Switched Telephone Network (PSTN) provides its users with dedicated, end-to-end circuit connections for the duration of each call. Based on the calling and called parties' numbers, circuits are reserved among an originating switch, any tandem switches along the route between the two ends of the call, and a terminating switch. Signaling between these PSTN switches supports basic call setup, call management, and call teardown as well as querying of databases to support advanced services such as local number portability, mobile subscriber authentication and roaming, virtual private networking, and toll-free service.

The conventional PSTN has served voice traffic well over the last 100 years, but its success has been paralleled by a rise of separate networks to support data traffic. These separate networks include, for example, the World-Wide Web which is commonly referred to as the Internet, an Intranet, a wide-area network (WAN), a local area network (LAN), an ATM, a T1 network, an E1 network, an Ethernet, a microwave network, a satellite network or the like, or a combination thereof. Clearly, use of distinct networks for voice and data represents an additional burden to service providers and an additional cost to consumers. As more and more PSTN traffic becomes data-oriented, however, the trend toward voice and data network convergence becomes stronger and stronger. Service providers, Internet service providers, and manufacturers of switching, transmission, and customer premises equipment are all participating in a significant shift of the telecommunications industry toward combined voice/video/data networking using IP.

The shift to IP telephony promises better efficiencies in the transport of voice and data, and, as a result, lower telecommunications costs to end users. Moreover, as IP telephony evolves, it will be able to match all the features of voice communications currently supported by the PSTN. Interoperability among the IP telephony products of different vendors is the first major hurdle to overcome. The real promise of IP telephony, however, will be realized with the next wave of advanced services that will begin to surpass the capabilities of the PSTN.

There are, however, some drawbacks associated with existing IP telephony systems. In VoIP systems, most VoIP clients need to connect to a VoIP proxy server in order to complete a call. After the VoIP client connects to the VoIP proxy server, the overall system can provide services for the VoIP client. In some conventional systems, the VoIP proxy server may connect to a routing server in order to obtain routing information to complete the call. Typically, the routing server executes a predefined static routing plan, i.e., the routing plan is not dynamically updated to select a termination PSTN gateway based on information collected from other components on the VoIP system. For example, a “health” status, a carrier termination cost, a Quality of Service of a termination PSTN gateway or a designation of a termination PSTN gateway group based on priority is not considered. The “health” status may include information on a network supporting the termination PSTN gateway, i.e., whether the network is up or has failed, or the termination PSTN gateway may have malfunctioned, or the like, for example. Therefore, the VoIP client is unable to connect to a more apt (e.g., appropriate, efficient, economical or the like) termination PSTN gateway.

In other instances, the routing server contacted by the VoIP client via the VoIP proxy server may lack information on the workload of each of the termination PSTN gateways in a termination PSTN gateway group at the destination. Therefore, the routing server is unable to select the termination PSTN gateway with the lowest workload. Thus, a termination PSTN gateway may become overloaded if too many clients attempt to connect to it resulting in degradation of Quality of Service. Additionally, the workload increases on the termination PSTN gateway, even though other termination PSTN gateways in the VoIP system may have much lower workloads.

One attempted solution is to configure the routing server to generate a request to connect to each termination PSTN gateway in each termination PSTN gateway group until one of the termination PSTN gateways accepts the request to connect. The client is then directed to connect to this particular termination PSTN gateway to complete the call. For example, the routing server may contact a primary termination PSTN gateway with a request to connect. If the primary termination PSTN gateway cannot accept the call, then the routing server transmits a request to a secondary termination PSTN gateway. The routing server may be configured to attempt to connect to each of the termination PSTN gateways in each termination PSTN gateway group in a predefined sequence by directly transmitting the request to connect to each one. This creates additional back and forth traffic between the routing server and the termination PSTN gateways.

Further, each attempt to connect increases the wait time for the VoIP client. For example, the routing server waits a predetermined amount of time to allow a termination PSTN gateway to process the request to connect. After the routing server waits the predetermined amount of time, the routing server times out the request and proceeds to generate another request to connect to the next termination PSTN gateway in the predefined sequence. Depending on the number of PSTN gateways contacted before one is identified as able to handle the call, the wait time of the VoIP client increases by the predetermined amount of time the routing server waits for each termination PSTN gateway contacted to process the request.

Another drawback is the information of the VoIP client is not taken into consideration. For example, in conventional systems most VoIP clients are not categorized into different groups, for example, by location of the VoIP client, by priority of the VoIP client, by business entity association of the VoIP client, by membership of the VoIP client in a high priority group, or the like. Therefore, each VoIP client uses the same routing plan on the routing server even though the requirement for Quality of Service may be different for different VoIP clients. For example, a single occasional user of a VoIP system may require a lower level of Quality of Service in order to communicate with friends and family over the VoIP system using a VoIP client such as a VoIP compatible computer. On the other hand, a business entity may require a higher Quality of Service in order for multiple simultaneous users to complete multiple simultaneous VoIP calls to multiple users over the VoIP system. Especially, if the calls include video teleconferencing calls. Additionally, the users may be located across the country or around the world. The business entity would expect a Quality of Service equal to the current conventional PSTN network.

Therefore, there exists a strong need in the art for a system and method which automatically identifies and utilizes an apt termination PSTN gateway for a particular user of a VoIP client. Such a system and method would provide the identity of the apt termination PSTN gateway to the VoIP client in order to more efficiently complete the call.

### SUMMARY OF THE INVENTION

According to one aspect of the invention, the invention is a Voice-over-Internet Protocol (VoIP) system. The VoIP system includes a network configured to allow voice data to be transmitted and received over the network. Further, the network includes a routing server configured to automatically determine and identify a termination PSTN gateway from a plurality of termination PSTN gateways. Additionally, the VoIP system includes at least one VoIP client operatively coupled to the network to transmit and receive voice data over the network. Further, the at least one VoIP client connects to the termination PSTN gateway in order to transmit and receive voice data. Further, the VoIP system includes one or more of a gateway monitor, a routing cost policy server or a routing plan database. The gateway monitor is configured to provide to the routing server the status information on the plurality of termination PSTN gateway. The routing cost policy server is configured to provide to the routing server cost information. The routing server may extract information on the at least one VoIP client from the routing plan database.

According to another aspect of the invention, the invention is a method for connecting at least one Voice-over-Internet Protocol (VoIP) client to a VoIP system. The VoIP system includes a network including a routing server and one or more of a gateway monitor, a routing cost policy server or a routing plan database. The method includes the steps of automatically determining and identifying a termination PSTN gateway from a plurality of termination PSTN gateways based on information provided by the one or more of the gateway monitor, the routing cost policy server of the routing database; and connecting of the at least one VoIP client to the termination PSTN gateway in order to transmit and receive voice data.

### BRIEF DESCRIPTION OF DRAWINGS

These and further features of the present invention will be apparent with reference to the following description and drawings, wherein:

FIG. 1 is a system level diagram of a VoIP system including a routing server configured to select automatically a termination PSTN gateway based on information collected on other components of the VoIP system according to an embodiment of the present invention;

FIG. 2 is a detailed schematic flow diagram representing a VoIP client connecting to the VoIP system using the routing server configured to select automatically the termination PSTN gateway in an embodiment of the present invention;

FIG. 3 is a flow diagram of a method for employing the routing server configured to select automatically the termination PSTN gateway according to the present invention;

FIG. 4 is a flow diagram of a method for automatically identifying the termination PSTN gateway based on predefined criteria according to an embodiment of the present invention; and

FIG. 5 is a flow diagram of a method for a VoIP client requesting a routing server to select automatically an apt termination PSTN gateway based on predefined criteria according to an embodiment of the present invention.

### DISCLOSURE OF INVENTION

To illustrate the present invention in a clear and concise manner, the drawings may not necessarily be to scale and certain features may be shown in a partial schematic format.

The present invention is a VoIP system including a routing server configured to select an apt termination PSTN gateway at the destination end of a VoIP call. The routing server utilizes information collected from other components of the VoIP system such as the designated caller group a VoIP client belongs to, the workload on a termination PSTN gateway, the group rating of a termination PSTN gateway, the “health” status of the termination PSTN gateway, the carrier termination cost for using a particular termination PSTN gateway, the availability of resources of a particular termination PSTN gateway.

In one embodiment, a VoIP client initially communicates with a VoIP proxy server. The VoIP proxy server communicates with a routing server. The routing server determines and identifies the apt termination PSTN gateway for the VoIP client that is able to handle the call.

Further, the invention includes a method for determining and identifying the apt termination PSTN gateway based on information collected by the routing server processing the request. Additionally, the routing server determines to which designated caller group does the VoIP client belong. If the routing server processing the request determines the VoIP client belongs to a high priority designated caller group, the routing server processing the request selects an apt termination PSTN gateway from a termination PSTN gateway group associated with the high priority designation and transmits a request thereto inquiring as to the termination PSTN gateway's ability to handle a call. Additionally, the method includes the routing server processing the request to determine whether the workload of the termination PSTN gateway is below a predefined workload threshold. Further, the method includes providing the identity of the apt termination PSTN gateway able to handle the call to the VoIP client so that the VoIP client may connect to that particular termination PSTN gateway in order to complete a call in an otherwise conventional manner.

The routing server is the portal through which the VoIP client connects to gain access to an apt termination PSTN gateway from a plurality of termination PSTN gateways in a plurality of termination PSTN gateway groups. When the routing server receives a client request to connect from a VoIP client wanting to connect to the VoIP system via a VoIP proxy server, the routing server is configured to select automatically the apt termination PSTN gateway.

The routing server determines which termination PSTN gateway in the level of service of the VoIP client can more efficiently handle the call. For example, the routing server determines whether or not the VoIP client is a member of a designated caller group which has a specific routing plan. Otherwise, the routing server processes the VoIP client request based on a default routing plan.

Additionally, the routing server takes into account other information such as the carrier termination cost for use of a particular termination PSTN gateway, the resources available to a particular termination PSTN gateway, or the designation of the PSTN gateway group. Additionally, the routing server takes into account the information of the particular VoIP client level of service such as the geographical location of the VoIP client, the type of VoIP client or the carrier the VoIP client is associated with.

Based on the information collected, the routing server determines which termination PSTN gateway groups meet all the criteria for the particular VoIP client. Based on a predefined criteria, the routing server determines which termination PSTN gateway group to begin identifying which termination PSTN gateway should be used in order to complete the call.

Next the routing server determines the workload on an identified termination PSTN gateway. If the identified termination PSTN gateway is above a predefined threshold, then the routing server determines and identifies a next termination PSTN gateway which meets all the criteria of the level of service of the VoIP client based on information collected by the routing server. The routing server then automatically generates a request to connect to the newly identified termination PSTN gateway. The newly identified termination PSTN gateway processes the request to connect and determines if its workload is below a predefined threshold and therefore is capable of handling a call.

If the workload of the termination PSTN gateway is below the predefined threshold, then the termination PSTN gateway responds to the request to connect to the routing server with its identity so that the VoIP client can continue the call setup process, otherwise it generates a negative response and the routing server proceeds to determine and identify another termination PSTN gateway with a low workload and generates and transmits a request to connect to the next termination PSTN gateway identified. This process of identifying a termination PSTN gateway with the lowest workload continues until a termination PSTN gateway is identified with the lowest workload that can also handle the call.

In response to the request to connect, the termination PSTN gateway able to handle the call provides its identity to the VoIP client via the routing server. The VoIP client then connects to the identified termination PSTN gateway and completes the call in an otherwise conventional manner. The VoIP client connects to the identified termination PSTN gateway for the duration of the call.

Thus, the apt termination PSTN gateway based on the level of service the VoIP client is entitled to is automatically selected to complete the call in the most efficient manner. Additionally, the workload on the termination PSTN gateways is balanced among the termination PSTN gateways.

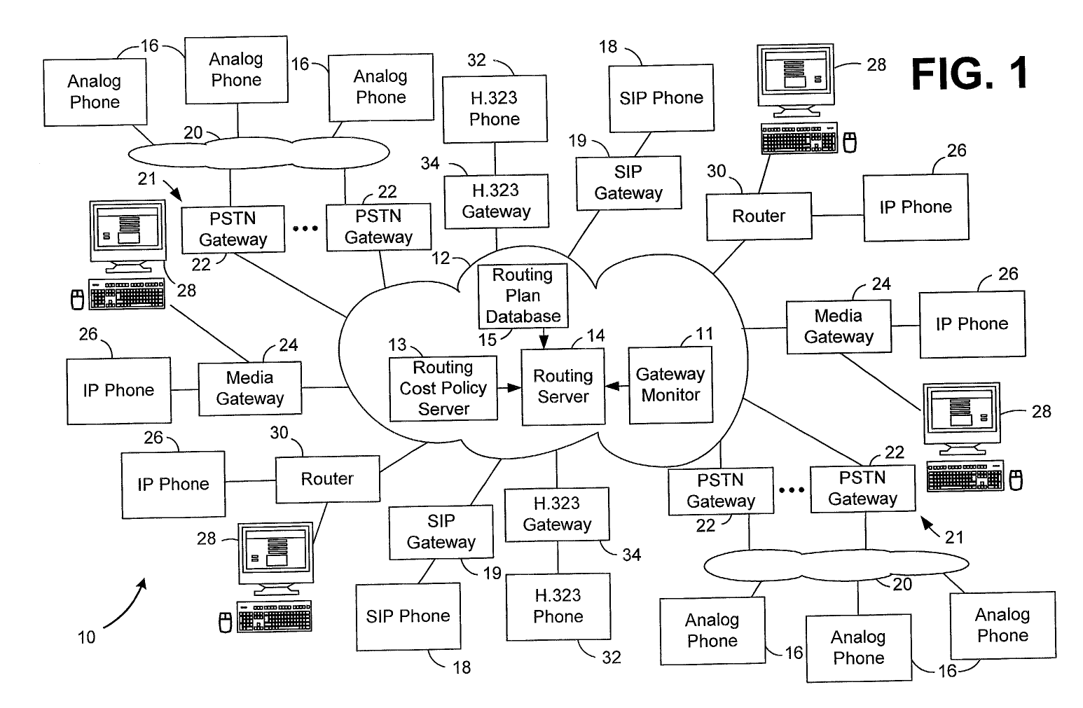

Referring initially to FIG. 1, an embodiment of a VoIP system, generally designated as 10, is shown. In the VoIP system 10, is a digital data network over which digitized voice signals are transmitted as a stream of packets. The underlying digital data network may be an IP network 12, for example, a proprietary network, a network of leased facilities, the Internet, an Intranet, a WAN, a LAN, a virtual private network (VPN), or the like, or a combination thereof. Within the IP network 12 are a plurality of VoIP proxy servers (not shown) configured to handle VoIP calls over the IP network 12. Additionally, within the IP network 12 are a plurality of routing servers configured to automatically select a termination PSTN gateway 22. The plurality of VoIP proxy servers and routing servers are coupled together, for example, via conventional network routing or other means known by those with ordinary skill in the art.

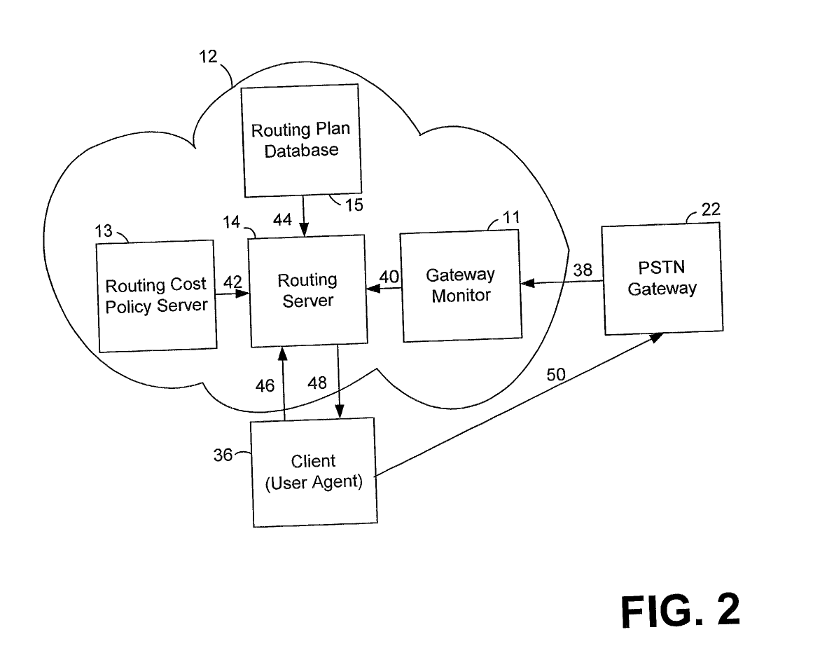

One of the plurality of routing servers is shown designated as a routing server 14. The routing server 14 is the portal through which a VoIP client accesses a termination PSTN gateway 22 on the VoIP system in order to complete a call to an analog phone on a conventional PSTN. The particular process by which a termination PSTN gateway 22 is identified to a VoIP client requesting to connect through the VoIP system to an analog phone on a conventional PSTN is transparent to the VoIP client. The operation of the routing server 14 in relation with a transmitting or calling VoIP client and a receiving VoIP client (i.e., an analog phone on a conventional PSTN), will be further explained below with reference to FIGS. 2-5.

A gateway monitor 11 may be coupled to the routing server 14. The gateway monitor 11 tracks the resource availability of every termination PSTN gateway 22 in the VoIP system 10. Additionally, a routing cost policy server 13 may be coupled to the routing server 14. The routing cost policy server 13 maintains and provides cost determination of each carrier in each specified region. The carriers may be for example AT&T, Sprint, MCI, BellSouth, or the like. The routing cost policy server 13 provides this information to the routing server 14. Additionally, a routing plan database 15 may be coupled to the routing server 14. The routing plan database 15 provides a user's information, a specified routing plan for predefined user groups, a mapping of destination numbers and termination PSTN gateway groups 21, information on termination PSTN gateways 22 or the like to the routing server 14. It should be understood that included in the IP network 12 will be other network devices to complete the network such as gateways, routers, switches, etc. (not shown).

In general, the gateway monitor 11 continuously monitors or tracks the status of the termination PSTN gateways 22 on the VoIP system 10. If the status of a termination PSTN gateway 22 changes, for example, a termination PSTN gateway 22 malfunctions and is unavailable, such a change is reported to the routing server 14 by the gateway monitor 11. Likewise, the routing cost policy server 13 maintains the cost of termination for each carrier and as it is updated it reports these changes to the routing server 14. Additionally, the routing server 14 downloads various kinds of information from the routing plan database 15 upon receipt of a call request to connect from a VoIP client. The routing server 14 uses the information provided by the gateway monitor 11, the routing cost policy server 13 and the routing plan database 15 in determining to which termination PSTN gateway 22 the VoIP client is eligible to connect to and is available to connect to.

In response to the request from the VoIP client via a VoIP proxy server, the routing server 14 provides the identity of the termination PSTN gateway 22 identified. Upon receipt of the identity of the termination PSTN gateway 22 identified, the VoIP client proceeds to connect with the identified termination PSTN gateway 22 in order to complete the call in an otherwise conventional manner.

In another embodiment upon receiving the request to connect, the routing server 14 downloads various kinds of information from the routing cost policy server 13. The routing cost policy server 13 retrieves such kinds of information from the routing plan database 15, and reports it to the routing server 14 as it is requested or updated. It should be understood that in this embodiment there would be no direct connection between the routing plan database 15 and the routing server 14 (FIGS. 1 and 2), but between the routing plan database 15 and the routing cost policy server 13.

A plurality of conventional analog phones 16 may be coupled to the IP network 12 via a local termination PSTN gateway group 21 including a plurality of local termination PSTN gateways 22. The plurality of analog phones 16 may be part of a local PSTN 20. Thus, the plurality of analog phones 16 may access the VoIP system 10 locally using known techniques.

Additionally, various “Session Initiation Protocol” (SIP) phones 18 may be coupled to the IP network 12 via a SIP gateway 19, for example. A plurality of IP phones 26 and/or computers 28, for example, may also be coupled to the IP network 12 via various media gateways 24 and/or various routers 30. Additionally, various H.323 phones 32 may be coupled to the IP network 12 via an H.323 gateway 34, for example.

Each computer 28 may have, for example, a pair of speakers and a microphone (not shown) or may have a headset with a microphone (not shown). Alternatively, a computer video camera with a microphone may be coupled to the computer 28 (not shown). The computer 28 may be a personal computer (PC) configured as a multimedia computer, a mobile computing device such as a laptop computer or the like. The computer 28 may execute logic, e.g., software, in order to place a VoIP call.

As will be appreciated, the analog phones 16, the SIP phones 18, the IP phones 26, the computers 28, the H.323 phones 32, etc., via their respective gateways or routers, represent VoIP clients within the VoIP system 10. The VoIP clients are each capable of making and receiving telephone calls via the IP network 12 by transmitting and receiving digital voice data packets therebetween. The actual procedures and protocols for exchanging such data employ conventional VoIP techniques except as otherwise described herein. Thus, the description herein focuses primarily on the inventive aspects.

Next, the general operation of the VoIP system 10 will be described. As previously mentioned, the VoIP system 10 utilizes VoIP technology to allow voice calls to be originated and terminated on various types of platforms over the IP network 12. For example, the analog phones 16 supported by a conventional PSTN can place and receive calls over the IP network 12. Alternatively, a SIP phone 18, an IP phone 26, a computer 28 or a H.323 phone 32 can place a call to an analog phone 16 on a local PSTN. The local PSTN may be in another city, state or country. Further still, a computer 28 could call an analog phone 16, another computer 28, a SIP phone 18, an IP phone 26, a cell phone (not shown), a satellite phone (not shown) or the like, or a combination thereof.

The VoIP technology translates a destination telephone number into a data network address (“IP address”) associated with a plurality of select termination PSTN gateways 22 and a plurality of termination PSTN gateway groups 21. The routing server 14 determines and identifies a particular termination PSTN gateway 22 based on a predefined criteria. Using an appropriate protocol and packet transmission over the IP network 12, the identified particular termination PSTN gateway 22 will initiate a call to the destination phone number over the local PSTN 20 at the receiving destination to completely establish end-to-end two-way communications. Despite the additional connections required, the overall call setup time is not significantly longer than with a call fully supported by a conventional PSTN.

In general, in order to complete a call by accessing the VoIP proxy servers on the IP network 12, a VoIP client establishes a connection with the routing server 14 via a VoIP proxy server. Next, the VoIP client requests to connect with an analog phone 16 identified by its destination telephone number. The routing server 14 determines to which designated caller or user group the VoIP client belongs. Next, the routing server 14 locates the routing plan for that user group. Next, the routing server 14 determines the termination PSTN gateway groups 21 nearest the destination phone number which belong to or otherwise meet the criteria of the selected routing plan. Next, the routing server 14 proceeds to determine the apt termination PSTN gateway group 21 from the plurality of termination PSTN groups 21 which matched all of the above criteria. The routing server may use availability of resources, cost, Quality of Service, location, or the like, or a combination thereof in order to identify the termination PSTN gateway group 21 from which to identify the termination PSTN gateway 22.

Next the routing server 14 determines which termination PSTN gateway 22 of the particular termination PSTN gateway group 21 has the lowest workload. The particular manner in which the predefined workload threshold is determined can be based on any of a variety of predetermined criteria including, for example, the amount of data being processed per second, the number of clients, the total number of ongoing calls, the number of calls processed per second, the CPU loading percentage, a statistical/mathematical model, or the like. The present invention is not intended to be limited necessarily to any particular criteria for establishing the predefined workload threshold.

Next, the routing server 14 generates a response to the VoIP client including the identity of the termination PSTN gateway 22 which has been selected as the apt termination PSTN gateway 22 to handle the call, e.g., its IP address. Upon receiving the response, the VoIP client proceeds to connect to the identified termination PSTN gateway 22 to complete the call.

Thus, the VoIP client wishing to make a call via the IP network 12 first requests to connect to an analog phone 16 via the routing server 14. The routing server 14 proceeds to determine and identify the apt termination PSTN gateway 22 near the destination number. The routing server 14 generates and transmits a request to connect to the termination PSTN gateways 22 experiencing the lowest workload of a termination PSTN gateway group 21 which meets the criteria of the VoIP client's level of service. The routing server 14 identifies which termination PSTN gateway 22 based on information passed by all termination PSTN gateways 22 via a network connection. The identified termination PSTN gateway 22 then determines whether it is able to handle the call. If it is unable to handle the call, the routing server 14 determines and identifies another termination PSTN gateway 22 with the next lowest workload to generate and transmit the request to connect. The first termination PSTN gateway 22 identified with a lower workload and able to handle call identifies itself to the VoIP client via the routing server 14. The VoIP client then establishes the call through that particular termination PSTN gateway 22 to complete the call in an otherwise conventional manner.

In this manner, the present invention automatically selects the appropriate termination PSTN gateway. This results in lower costs, proper level of service for the VoIP client, and better use of resources. Additionally, the present invention helps to avoid one or more termination PSTN gateways 22 shouldering the majority of the workload while other of the termination PSTN gateways 22 are underutilized at any given moment in time. This way, more optimum network connections may be established for each call, thereby reducing latency time, etc.

Additionally, the VoIP client only needs to connect initially to the routing server 14. The automatic selection of an apt termination PSTN gateway 22 takes place totally transparent to the VoIP client. Further, this reduces the back and forth traffic between the routing server 14, and the termination PSTN gateways 22 if the same process was done by the routing server 14 without the additional information.

In the VoIP system 10, voice signals are digitized and transmitted as a stream of packets over the IP network 12. The IP network 12 allows each packet to find independently the most efficient path to the intended destination, thereby best using the network resources at any given instant. The packets associated with a single source may thus take many different paths to the destination in traversing the IP network 12, arriving with different end-to-end delays, arriving out of sequence, or possibly not arriving at all. At the destination, however, the packets are re-assembled and converted back into the original voice signal. VoIP technology insures proper reconstruction of the voice signals, compensating for echoes made audible due to the end-to-end delay, for jitter, and for dropped packets, etc.

Turning now to FIG. 2, the IP network 12 is represented with a representative VoIP client 36 (hereinafter client 36) attempting to connect to termination PSTN gateway 22 via the routing server 14 in order to complete a VoIP call in accordance with the invention. Additionally, the gateway monitor 11, the routing cost policy server 13 and the routing plan database 15 are coupled to the routing server 14.

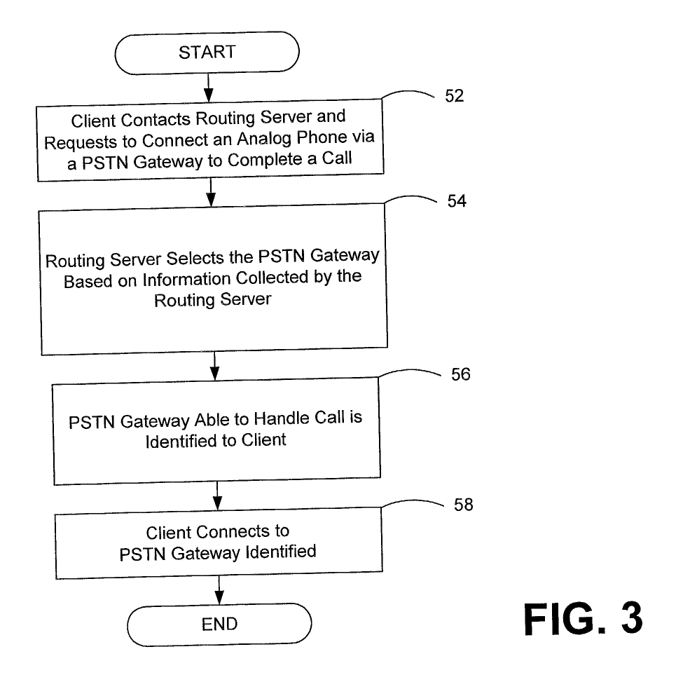

It should be understood that the client 36 may be any device capable of transmitting and receiving voice or video data over a VoIP system 10. For example, the client 36 may take the form of one of the analog phones 16, the SIP phones 18, the IP phones 26, the computers 28, etc., which connect to the IP network 12 via its respective gateway or router. The steps of the call connection process will now be further explained with reference to FIGS. 3-5.

Referring now to FIG. 3, the overall process is shown for identifying a termination PSTN gateway 22 in the VoIP system 10 in accordance with the present invention. In step 52, the routing server 14 receives a client request to connect via a VoIP proxy server from the client 36 requesting to connect to an analog phone 16 via a termination PSTN gateway 22 in order to place a VoIP call. The client request to connect is represented by network connection line 46 in FIG. 2.

Next in step 54, the routing server 14 determines and identifies a termination PSTN gateway 22 based on information collected by the routing server 14 via the gateway monitor 11, the routing cost policy server 13 and the routing plan database 15. The routing server 14 identifies which termination PSTN gateway 22 in a termination PSTN gateway group 21 which meets all the criteria of the VoIP client's level of service. This includes the routing plan of the caller group of the VoIP client, the level of service the VoIP client is entitled to, the termination cost of the termination PSTN gateway, etc. The routing server determines which termination PSTN gateway 22 of the lowest cost termination PSTN gateway group 21 has the lowest workload. This may be done by comparing the workload data provided to the routing server 14 from each of the termination PSTN gateways 22 via the termination PSTN gateway monitor 11. In another embodiment, additional factors unrelated to workload may be used to determine to which termination PSTN gateway 22 to request to connect. These additional factors unrelated to workload may include the location/region of the termination PSTN gateway 22, the servicing of the termination PSTN gateway 22, the Quality of Service rating, or the like.

The routing server 14 then automatically generates and transmits a request to connect to the identified termination PSTN gateway 22. The identified termination PSTN gateway 22 determines whether its workload is below the predefined threshold, as described above, and therefore can handle the call.

For this example, a termination PSTN gateway 22 is identified meeting the client's level of service criteria, as explained above, and having the lowest workload. The termination PSTN gateway 22 also has determined it was able to handle the call. The generating and transmitting of information on the status of the termination PSTN gateway 22 to the gateway monitor 11 as represented by network connection line 38 in FIG. 2. The forwarding of the information by the gateway monitor 11 to the routing server 14 to is represented by network connection line 40 in FIG. 2. The forwarding of information on routing cost by the routing cost policy server 13 to the routing server 14 is represented by network connection line 42 in FIG. 2. Additionally, the passing of routing plan information including client information from the routing plan database 15 to the routing server 14 is represented by network connection line 44 in FIG. 2. It should be understood the above process of generating and transmitting a request to connect to a termination PSTN gateway 22 with a lower workload continues until the request is received by a termination PSTN gateway 22 whose workload is determined to be below the predefined threshold and therefore is capable of handling the call.

Next in step 56, the routing server 14 then generates and transmits a response to the request to connect to the VoIP client. The identity of the termination PSTN gateway 22 may be, for example, an IP address or the like which the routing server 14 provides to the client 36.

Next in step 58, the client 36 connects using known network protocols, etc., to the termination PSTN gateway 22 identified as able to handle the call in order to complete the VoIP call in an otherwise conventional fashion. In FIG. 2, termination PSTN gateway 22 represents the termination PSTN gateway 22 identified as having the workload below the predefined threshold. The connection of client 36 to the termination PSTN gateway 22 is represented by network connection line 50 in FIG. 2.

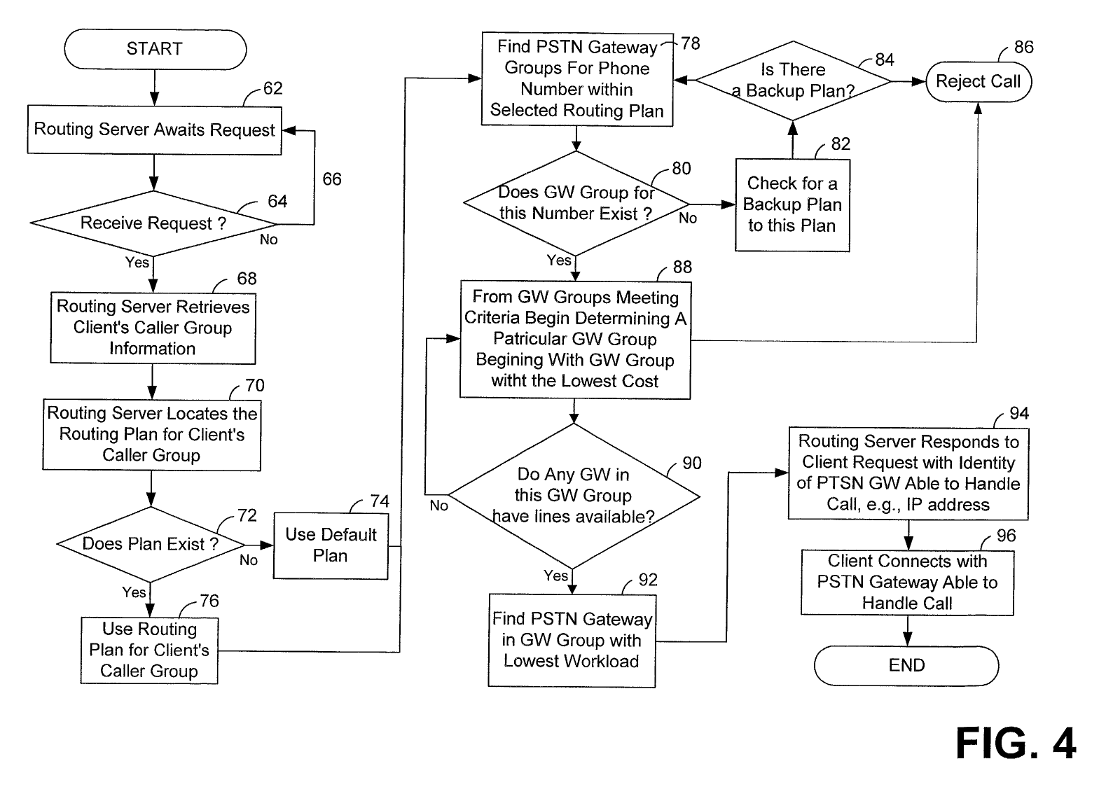

Now referring to FIG. 4, the specific steps carried out by the routing server 14 configured to automatically identifying the termination PSTN gateway 22 able to handle a call, e.g., the first termination PSTN gateway 22 with a workload below the predefined threshold will be described. In step 62, the routing server 14 is configured to wait for a client request to connect to be received from the client 36 via a VoIP proxy server before determining the apt termination PSTN gateway 22. Next in step 64, the routing server 14 determines whether it has received a client request to connect to an analog phone 16 on a local PSTN 20 on the VoIP system 10. If “no”, then the routing server 14 returns to step 62 to continue to wait for a client request to connect. The return to step 62 is represented by line 66. However, if the answer is “yes”, then the routing server 14 proceeds to determine the VoIP client's caller group information in step 68.

In step 68, the routing server 14 determines to which caller group the VoIP client belongs. The particular manner in which the caller group is determined can be based on any of a variety of methods including, for example, a caller ID number, a group ID number, an exchange, the location, the type of client, or the like. The present invention is not intended to be limited necessarily to any particular method for establishing the client's caller group.

Next in step 70, the routing server 14 proceeds to locate the routing plan for that user group. In step 72, the routing server 14 determines if a routing plan exists. If the routing plan exists, then, in step 76, the routing server 14 uses the routing plan for the caller group. Otherwise in step 74, the routing server 14 uses a default routing plan. Next in step 78, the routing server 14 determines the termination PSTN gateway groups 21 nearest the destination phone number which meet the criteria of the selected routing plan. Next in step 80, the routing server 14 determines whether a termination PSTN gateway group 21 for the phone number exists. If no termination PSTN gateway group 21 exists for the phone number, then, in step 82, the routing server 14 checks for a back-up plan to the routing plan. In step 84, the routing server 14 determines whether a back-up plan exists. If a back-up plan does exist, then the routing server 14 returns to step 78 to determine a termination PSTN gateway group 21 for the phone number based on the back-up plan and proceeds to step 80 to determine whether a termination PSTN gateway group 21 exists for this phone number in the back-up plan. Otherwise, if no back-up plan exists in step 84, the call is rejected in step 86.

Assuming the VoIP client has a routing plan and a termination PSTN gateway group 21 exists in step 80, the routing server 14 proceeds to step 88 in order to determine the apt termination PSTN gateway group 21 from the termination PSTN gateway groups 21 which matched all of the above criteria. The routing server 14 begins from the lowest cost termination PSTN gateway group 21 and proceeds to the higher cost termination PSTN gateway groups 21.

Next in step 90, the routing server 14 determines whether any of the termination PSTN gateways 22 of the lowest cost termination PSTN gateway group 21 has lines available. If not, the process returns to the previous step, i.e., step 88 and the routing server 14 proceeds to select the next least costly termination PSTN gateway group 21 and proceeds to determine whether a termination PSTN gateway 22 of the newly selected termination PSTN gateway group 21 has lines available. The process continues to loop through steps 88 and 90 until a termination PSTN gateway 22 of one of the termination PSTN gateway groups 21 has lines available. Otherwise if no termination PSTN gateway 22 of the termination PSTN gateway group 21 has a line available, then the call is rejected in step 86.

If multiple termination PSTN gateways 22 in the selected termination PSTN gateway group 21 have lines available, then, in step 92, the routing server 14 determines which termination PSTN gateway 22 of the identified termination PSTN gateway group 21 has the lowest workload. The particular manner in which the predefined workload threshold is determined can be based on any of a variety of predetermined criteria including, for example, the amount of data being processed per second, the number of clients, the total number of ongoing calls, the number of calls processed per second, the CPU loading percentage, a statistical/mathematical model, or the like. The present invention is not intended to be limited necessarily to any particular criteria for establishing the predefined workload threshold.

Next in step 94, the routing server 14 generates a response to the VoIP client including the identity of the termination PSTN gateway 22 which has been selected as the apt termination PSTN gateway 22 to handle the call, e.g., its IP address. Next in step 96, upon receiving the response, the VoIP client 36 proceeds to connect to the identified termination PSTN gateway 22 to complete the call in an otherwise conventional manner.

The routing server 14 determines and identifies a termination PSTN gateway 22 based on information collected by the routing server 14 via the gateway monitor 11, the routing cost policy server 13 and the routing plan database 15.

For example, the routing server 14 may be configured to collect the information from each of the termination PSTN gateways 22 in each of the termination PSTN gateway groups 21. In one embodiment, each termination PSTN gateway 22 via a network connection may pass its information spontaneously to the gateway monitor 11. Alternatively, the gateway monitor 11 may poll each of the termination PSTN gateways 22 for its respective information. Further still, gateway monitor 11 may continuously collect the information on a network connection. If the information is workload information, it may be provided in a plurality of ways, for example, each VoIP proxy server may receive statistics from the respective VoIP proxy servers as to the current workload at each VoIP proxy server, for example, the amount of data being processed per second, the number of clients, the total number of ongoing calls, the number of calls processed per second, the CPU loading percentage, the result(s) of a statistical/mathematical model, or the like.

The routing server 14 identifies which termination PSTN gateway 22 in a termination PSTN gateway group 21 which meets all the criteria of the VoIP client's level of service has the lower workload. This may be done by comparing the workload data provided to the routing server 14 from each of the termination PSTN gateways 22 via the termination PSTN gateway monitor 11. In another embodiment, factors unrelated to workload may be used to determine to which termination PSTN gateway 22 to request to connect. The factors unrelated to workload may include the cost to use a particular termination PSTN gateway 22, the location/region of the termination PSTN gateway 22, the servicing of the termination PSTN gateway 22, the Quality of Service rating, or the like.

The routing server 14 then automatically generates and transmits a request to connect to the identified termination PSTN gateway 22. The identified termination PSTN gateway 22 determines whether its workload is below the predefined threshold, as described above, and therefore can handle the call. The above process of generating and transmitting a request to connect to a termination PSTN gateway 22 with a lower workload continues until the request is received by a termination PSTN gateway 22 whose workload is determined to be below the predefined threshold and therefore is capable of handling the call. The termination PSTN gateway 22 thus able to handle the call generates and transmits a response including its identity to the routing server 14, which in turn, forwards the identity to the requesting VoIP client. Such identification may be by an IP address, for example. Once the VoIP client receives the response identifying the termination PSTN gateway 22 able to handle the call, the VoIP client connects to the termination PSTN gateway 22 identified in order to establish the call in an otherwise conventional manner.

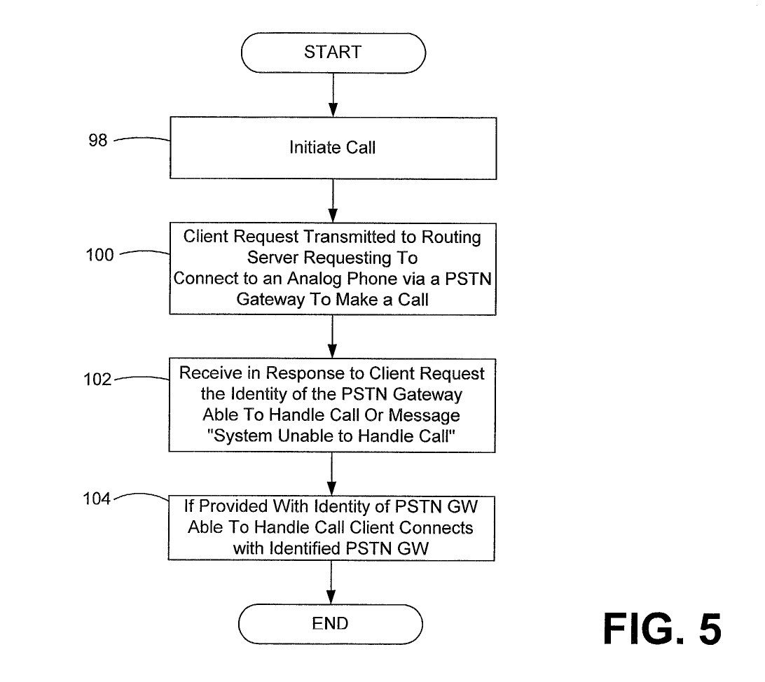

Now referring to FIG. 5, the steps carried out by the client 36 making the call and requesting to connect to an analog phone 16 on a local PSTN 20 on the VoIP system 10 will be described. In step 98, a user of the VoIP system 10 initiates a call on the VoIP system via a VoIP client (e.g., the analog phones 16, the SIP phones 18, the IP phones 26, etc.). The user may, for example, pick up the receiver of the IP phone 26. Alternatively, the user may execute a VoIP program on the VoIP compatible computer 28. Further still, the user may pick up a receiver of the analog phone 16.

In step 100, the client 36 via a VoIP proxy server transmits the client request to connect to the routing server 14 (represented by network connection line 46 in FIG. 2). As previously described, such client request to connect asks the routing server 14 to which termination PSTN gateway 22 to connect in order to complete the call.

Next in step 102, the client 36 receives a packet from the routing server 14 containing the response to the client request to connect including the identity of the termination PSTN gateway 22 able to handle the call. In step 104, the client 36 then proceeds to connect with the identified termination PSTN gateway 22 as represented by line 50 (FIG. 2) in order to establish the call in an otherwise conventional manner.

It will further be appreciated that the VoIP system 10 may alternatively have configurations other than the configurations shown in FIG. 1. Thus, there has been disclosed a system and method for automatically selecting the apt termination PSTN gateway 22 able to handle a call, and providing such identity to a VoIP client so the VoIP client may connect to the VoIP system 10 in order to make a VoIP call. This method permits the more efficient use of the termination PSTN gateways 22 by balancing the workload among the termination PSTN gateways 22 more efficiently.

Additionally, although the flow charts of FIGS. 3-5 show a specific order of execution, it is understood that the order of execution may differ from that which is depicted. For example, the order of execution of two or more blocks may be scrambled relative to the order shown. Also, two or more blocks shown in succession in FIGS. 3-5 may be executed concurrently or with partial concurrence.

It will further be appreciated that each of the respective devices described herein is programmed via conventional computer programming techniques to execute machine-readable code in order to carry out the operations described herein. Such programming may be easily performed by those having ordinary skill in the art of computer programming and IP technology based on the disclosure herein. Accordingly, the particular details of such programming code have been omitted for the sake of brevity.

Although particular embodiments of the invention have been described in detail, it is understood that the invention is not limited correspondingly in scope, but includes all changes, modifications and equivalents coming within the spirit and terms of the claims appended hereto.

What is claimed is:

1. A Voice-over-Internet Protocol (VoIP) system, comprising:
a network configured to allow voice data to be transmitted and received over the network wherein the network includes a routing server configured to automatically determine and identify a termination PSTN gateway from a plurality of termination PSTN gateways;
at least one VoIP client operatively coupled to the network to transmit and receive voice data over the network; wherein the at least one VoIP client connects to the termination PSTN gateway in order to transmit and receive voice data; and
one or more of a gateway monitor configured to provide to the routing server the status information on the plurality of termination PSTN gateways, a routing cost policy server configured to provide to the routing server cost information or a routing plan database from which the routing server may extract information on the at least one VoIP client.

2. The VoIP system according to claim 1, further including at least one network connection coupled to the routing server and the one or more of the gateway monitor, the routing cost policy server, or the routing plan database for sharing information therebetween and the information is used to determine which termination PSTN gateway of the plurality of termination PSTN gateways the at least one VoIP client connects to in order to transmit and receive voice data.

3. The VoIP system according to claim 1, wherein the plurality of termination PSTN gateways are configured in a plurality of termination PSTN gateway groups which are designated based on the Quality of Service and the designation is used by the routing server to determine and identify the termination PSTN gateway.

4. The VoIP system according to claim 1, wherein the at least one VoIP client is categorized in a caller group and the caller group is used by the routing server to determine and identify the termination PSTN gateway.

5. The VoIP system according to claim 4, wherein the caller group is categorized by one or more of a location, a priority, a business entity association, or a membership of the client.

6. The VoIP system according to claim 4, further including a routing plan associated with the caller group and the routing plan is used by the routing server to determine and identify the termination PSTN gateway.

7. The VoIP system according to claim 4, further including a default routing plan associated with the caller group and the default routing plan is used by the routing server to determine and identify the termination PSTN gateway.

8. The VoIP system according to claim 1, wherein the routing server identifies the termination PSTN gateway based on workload data.

9. The VoIP system according to claim 1, wherein the gateway monitor continuously monitors the plurality of termination PSTN gateways for status information.

10. The VoIP system according to claim 1, wherein the gateway monitor polls the plurality of termination PSTN gateways for status information.

11. The VoIP system according to claim 1, wherein the status information includes one or more of a health status, a carrier termination cost, a Quality of Service of a termination PSTN gateway, a termination PSTN gateway malfunction indication, a network supporting the termination PSTN gateway status, or the availability of resources of the termination PSTN gateway.

12. The VoIP system according to claim 1, wherein the routing plan database is coupled to the routing server and shares information therebetween, the information is used by the routing server to determine which termination PSTN gateway of the plurality of termination PSTN gateways the at least one VoIP client connects to in order to transmit and receive voice data.

13. The VoIP system according to claim 1, wherein the routing plan database is coupled to the routing cost policy server in order to share information therebetween and the routing cost policy server is coupled to the routing server to share information therebetween and the information is used to determine which termination PSTN gateway of the plurality of termination PSTN gateways the at least one VoIP client connects to in order to transmit and receive voice data.

14. A method for connecting at least one Voice-over-Internet Protocol (VoIP) client to a VoIP system, wherein the VoIP system comprises a network including a routing server, and one or more of a gateway monitor, a routing cost policy server or a routing plan database; comprising the steps of:
(a) automatically determining and identifying a termination PSTN gateway from a plurality of termination PSTN gateways based on information provided by the one or more of the gateway monitor, the routing cost policy server or the routing database; and
(b) connecting of the at least one VoIP client to the termination PSTN gateway in order to transmit and receive voice data.

15. The method of claim 15, further including the step of:
(c) sharing information between the plurality of termination PSTN gateways and the routing server wherein the information is used by the routing server to determine which termination PSTN gateway of the plurality of termination PSTN gateways the at least one VoIP client connects to in order to transmit and receive voice data.

16. The method of claim 14, further including the steps of:
(d) configuring the plurality of termination PSTN gateways into a plurality of termination PSTN gateway groups;
(e) designating the plurality of termination PSTN gateway groups based on the Quality of Service; and
(f) using the designation to determine and identify the termination PSTN gateway.

17. The method of claim 14, further including the step of identifying the termination PSTN gateway based on workload data received by the routing server.

18. The method of claim 14, further including the step of categorizing the at least one VoIP client into a caller group wherein the caller group is used by the routing server to determine and identify the termination PSTN gateway.

19. The method of claim 18, further including the step of:
(g) identifying a routing plan associated with the caller group and the routing plan is used by the routing server to determine and identify the termination PSTN gateway.

20. The method of claim 18, further including the step of identifying a default routing plan associated with the caller group and the default routing plan is used by the routing server to determine and identify the termination PSTN gateway.
